(19) United States
(12) Patent Application Publication
(10) Pub. No.: US 2007/0108732 A1
(43) Pub. Date: May 17, 2007

(54) Pintle hitch lock

(76) Inventor: Frank W. Silva II, Fort Wayne, IN (US)

Correspondence Address: TAYLOR & AUST, P.C., 142 SOUTH MAIN STREET, P. O. BOX 560, AVILLA, IN, 46710, US

(21) Appl. No.: 11/273,883

(22) Filed: Nov. 15, 2005

(51) Int. Cl. B60D 1/60

(52) U.S. Cl. 280/507

(57) ABSTRACT

A pintle hitch lock for locking a trailer hitch including a trailer tongue with a pintle ring. The pintle hitch lock includes a jam configured for mounting through the pintle ring. A clasp is connected to the jam, and the clasp is configured for connection to the trailer tongue. A pin is insertable through the clasp.

### BACKGROUND OF THE INVENTION

1. Field of the invention.

The present invention relates to trailer hitch locks, and, more particularly, to a pintle hitch lock.

2. Description of the related art.

Trailers are known, such as military trailers, construction trailers, rental trailers, horse trailers, cargo trailers, boat trailers, recreational vehicle travel trailers and the like, which are pulled by a tow vehicle such as a truck. In order to connect the trailer to the tow vehicle, the trailer can have a tongue with pintle hitch including a pintle ring, which is sometimes also known as a lunette eye. The tow vehicle can have a corresponding pintle hook which connects to the pintle ring. It is sometimes necessary to disconnect the trailer from the tow vehicle, to travel separately in the tow vehicle for various purposes or to park the tow vehicle in a separate area, and thereby leave the trailer unattended and/or unconnected. Under such circumstances, a security device which can inhibit connection to the trailer hitch can be advantageous in that such a security device can inhibit an unauthorized entity from easily connecting to the trailer with another tow vehicle, and thereby absconding with the trailer.

A protective lock assembly is known which is mounted within a hitch which is part of a trailer tongue. The hitch is in the form of a ring and the protective lock assembly includes a first plate seated on the upper surface of the hitch ring, where extending from the plate is a post or tongue which extends from the plate at a given distance. One outer end of the tongue is provided an element for allowing engagement of a shackle or lock bolt of lock. One disadvantage of this protective device is that it is relatively complex and expensive to manufacture. Another disadvantage is that if the hitch ring is removed from the trailer and replaced with another ring, the protective lock assembly is also thereby removed.

Another locking device is known which can be inserted within an eye of a pintle ring to prevent the theft of a trailer, and which includes a lower base portion with a locking portion and an upper lock portion which includes a flat mounting base to which is mounted a commercially available shank lock. This protective device is also relatively complex and expensive to manufacture, and has the additional disadvantage that if the hitch ring is removed from the trailer and replaced with another ring, the protective lock assembly is also thereby removed.

What is needed in the art is pintle hitch lock which is a simpler and more cost effective design, and which connects to the trailer tongue and through the hitch ring.

### SUMMARY OF THE INVENTION

The present invention provides a pintle hitch lock which is a simple and cost effective design which connects to the trailer tongue and through the hitch ring.

The invention comprises, in one form thereof, a pintle hitch lock for locking a trailer hitch including a trailer tongue with a pintle ring. The pintle hitch lock includes a jam configured for mounting through the pintle ring. A clasp is connected to the jam, and the clasp is configured for connection to the trailer tongue. A pin is insertable through the clasp.

The invention comprises, in another form thereof, a trailer with a trailer tongue which has a pintle ring and a pintle hitch lock connected to the trailer tongue. The pintle hitch lock includes a jam mounted through the pintle ring. A clasp is connected to the jam, and the clasp is connected to the trailer tongue. A pin is inserted through both the clasp and the trailer tongue.

The invention comprises, in yet another form thereof, a method of locking from use a pintle ring on a trailer, the method including: providing a pintle hitch having a jam configured for mounting through the pintle ring; a clasp connected to the jam; and a pin insertable through the clasp; inserting the jam through the pintle ring; and connecting the clasp to the tongue.

An advantage of the present invention is that it provides a security device which inhibits an unauthorized entity from connecting to the trailer with another tow vehicle.

Another advantage of the present invention is that it is a simpler and more cost effective design to manufacture.

Yet another advantage of the present invention is that it connects to the trailer tongue and through the hitch ring.

Yet another advantage of the present invention is that it is not disabled by removing the hitch ring.

Yet another advantage of the present invention is that it minimizes the use of machined parts and thereby reduces cost.

Yet another advantage of the present invention is that it can use a readily available padlock and therefore does not require a complex locking mechanism.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective fragmentary view of an embodiment of a trailer including a pintle hitch lock according to the present invention;

FIG. 2 is an exploded perspective fragmentary view of the embodiment of FIG. 1;

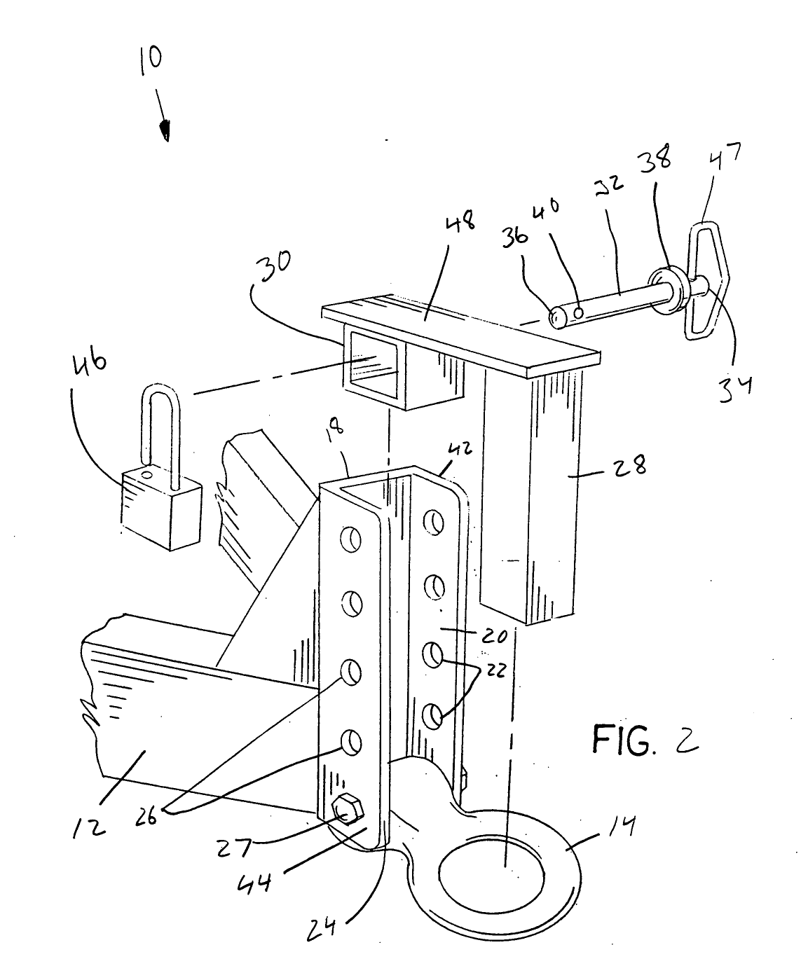

FIG. 3 is an exploded perspective view of the pintle hitch lock of FIG. 1;

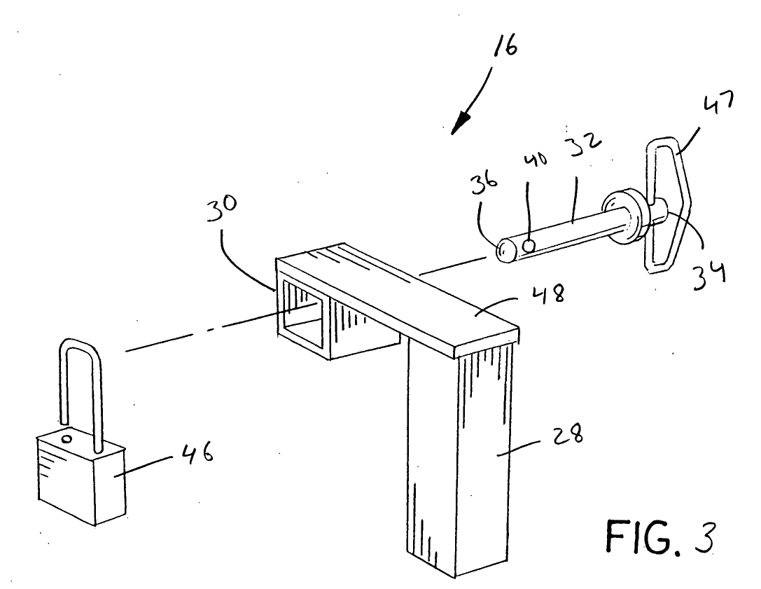

FIG. 4 is an fragmentary side view of the embodiment of FIG. 1;

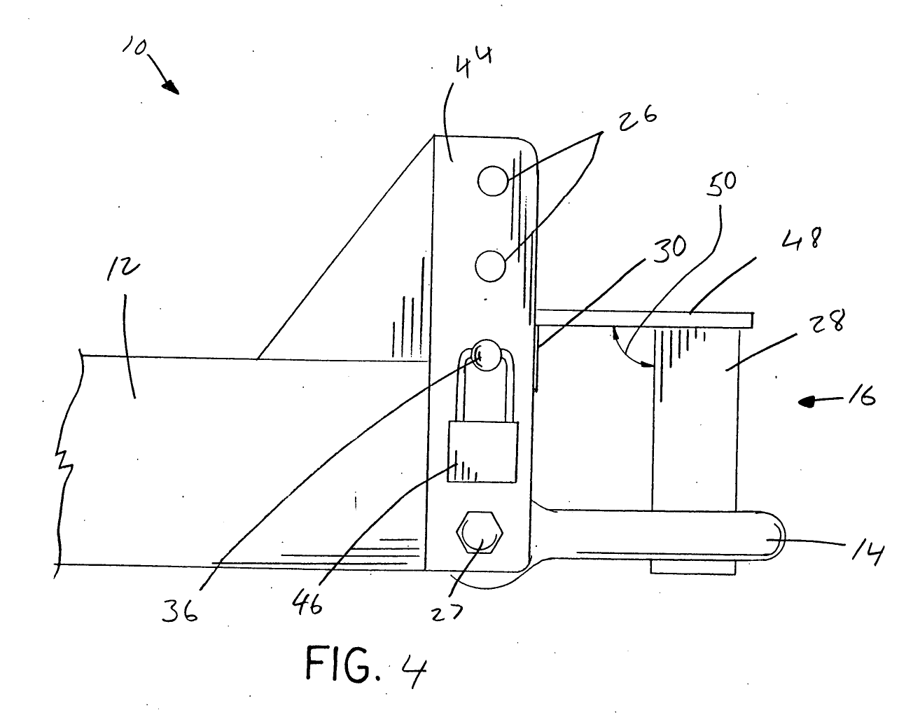

FIG. 5 is an exploded perspective view of another embodiment of the pintle hitch lock of the present invention;

FIG. 6 is an exploded perspective view of another embodiment of the pintle hitch lock of the present invention;

FIG. 7 is an exploded perspective view of another embodiment of the pintle hitch lock of the present invention;

FIGS. 8-11 are perspective views showing a method of manufacture of the pintle hitch lock of FIG. 7; and

FIG. 12 is a side view of another embodiment of the pintle hitch lock of the present invention.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

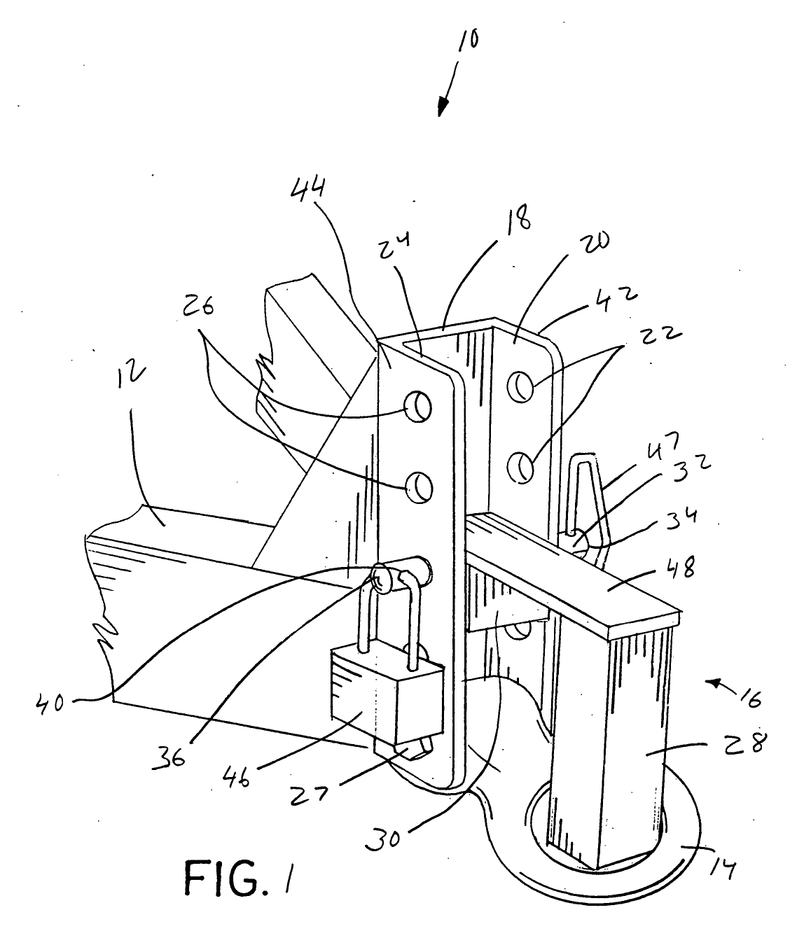

Referring now to the drawings, and more particularly to FIG. 1, there is shown a trailer 10 which generally includes a trailer tongue 12 which has a pintle ring 14, and a pintle hitch lock 16 is connected to pintle ring 14.

Trailer 10 can be, for example, a military trailer, a construction trailer, a rental trailer, a horse trailer, a cargo trailer, a boat trailer, a recreational vehicle travel trailer and the like, which are pulled by a tow vehicle such as a truck (not shown). Trailer 10 can include other elements such as a chassis, at least one axle connected via a suspension to the chassis with wheels connected to the axle(s), and a body connected to the chassis. The body can include other elements such as doors, stalls, fixtures, etc., as are known and appropriate for the type of trailer. Trailer tongue 12 is typically connected to the trailer chassis. Pintle ring 14 can connect to a corresponding pintle hook (not shown) on a tow vehicle. Trailer tongue 12 can have an adjustment channel 18 for adjustably connecting pintle ring 14 to tongue 12, thereby allowing pintle ring 14 to be adjusted for proper vertical position relative to the pintle hook on the tow vehicle. Adjustment channel 18 can have a first plate 20 with a first plurality of holes 22 and an opposing second plate 24 with a second plurality of holes 26. Pintle ring 14 can be connected to adjustment channel 18 with fastener 27.

Pintle hitch lock 16 includes a jam 28 mounted through pintle ring 14. A clasp 30 is connected to jam 28, and clasp 30 can be connected to trailer tongue 12. A pin 32 is inserted through both clasp 30 and trailer tongue 12.

Pin 32 includes a first end 34 and a second end 36. First end 34 can have a stop 38, and second end 36 can have an aperture 40. Pin 32 is mounted through one of holes 22 and one of holes 26. When pin 32 is inserted into adjustment channel 18, stop 38 can be on an outside 42 of first plate 20, for example, and aperture 40 can be on an outside 44 of second plate 24. Alternatively, when pin 32 is inserted into adjustment channel 18, stop 38 can be on outside 44 of second plate 24 and aperture 40 can be on an outside 42 of first plate 20. A padlock 46 can be inserted through aperture 46 to hold pin 32 on adjustment channel 18, and thereby hold jam 28 within pintle ring 14. Padlock 46 can be a keyed lock or combination lock, or alternatively, other locks can be used such as cable locks and the like. Pin 32 can also include handle 47 to facilitate the insertion and release of pin 32 into adjustment channel 18 and clasp 30.

A plate 48 connects jam 28 with clasp 30. Jam 28 can be a rectangular tube or a rectangular bar, for example. Jam 28 can extend from plate 48 at an angle 50 of approximately 90°, although other angles between 0° and 180° are possible. Clasp 30 can be a rectangular tube, for example. Plate 48, jam 28 and clasp 30 can be fabricated and welded together, for example.

In use, the present invention provides a method of locking from use a pintle ring 14 on a trailer 10, the method including: providing a pintle hitch lock 16 having a jam 28 configured for mounting through pintle ring 14, a clasp 30 connected to jam 28, and a pin 32 insertable through clasp 30; inserting jam 28 through pintle ring 14; and connecting clasp 30 to trailer tongue 12. The method of the present invention can further include the step of mounting pin 32 through one of holes 22 and one of 26 holes, and clasp 30. The method of the present invention can further include the step of connecting padlock 46 to pin 32.

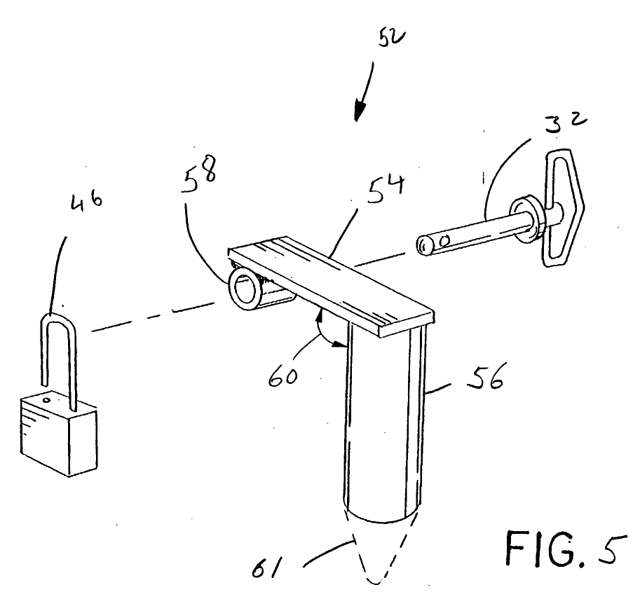

In the embodiment of FIG. 5, pintle hitch lock 52 includes plate 54 which connects jam 56 with clasp 58. Jam 56 can be a circular tube or a circular bar, for example. Jam 56 can extend 10 from plate 54 at an angle 60 of approximately 90°, although other angles between 0° and 180° are possible. Clasp 58 can be a circular tube, for example. Pintle hitch lock 52 further includes pin 32 and padlock 46. Plate 54, jam 56 and clasp 58 can be fabricated and welded together, for example. Jam 56 can include an end 61, shown in dashed line, which is flat, cone shaped, bullet shaped or pointed, rounded or other shapes, as can other embodiments of the jam.

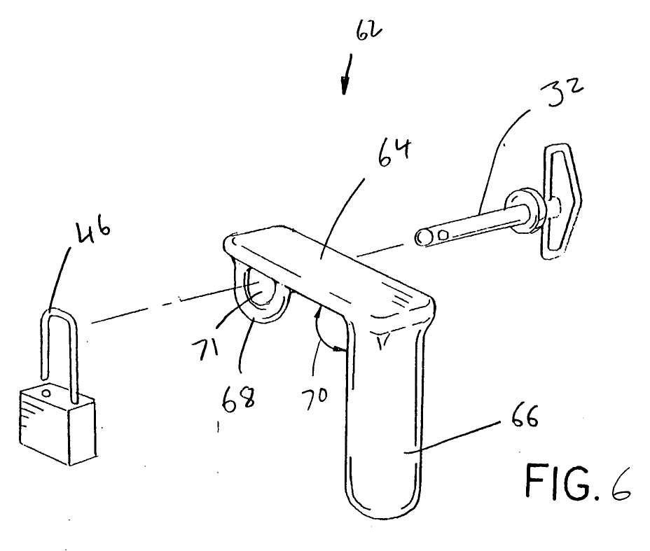

In the embodiment of FIG. 6, pintle hitch lock 62 is shown in a form suitable for a casting manufacture of pintle hitch lock 62. Pintle hitch lock 62 includes plate 64 which connects jam 66 with clasp 68. Jam 66 can be a circular tube or a circular bar, for example. Jam 66 can extend from plate 64 at an angle 70 of approximately 90°, although other angles between 0° and 180° are possible. Clasp 68 can be a u-shaped or other shaped ring, for example. Pintle hitch 20 lock 62 further includes pin 32 and padlock 46. Hole 71 in jam 66 can be elongated to fit different sized locks or pins, and/or hole 71 can be off-center.

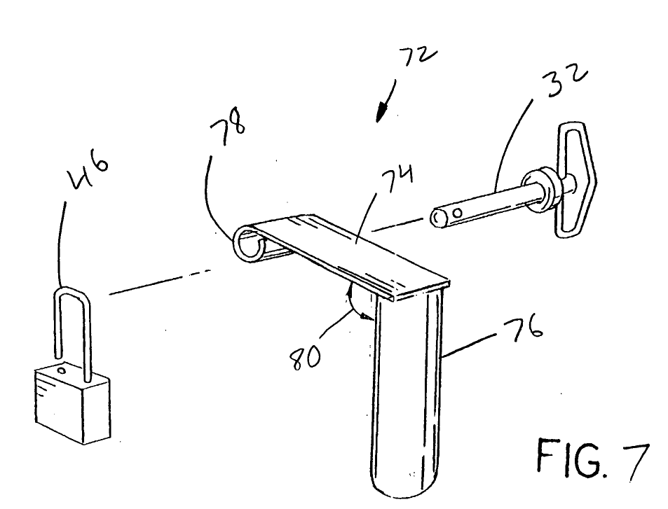

In the embodiment of FIG. 7, pintle hitch lock 72 is shown in a form suitable for a bent/rolled forming of pintle hitch lock 72. Pintle hitch lock 72 includes plate 74 which connects jam 76 with clasp 78. Jam 76 can be a circular tube or a rectangular tube, for example. Jam 76 can extend from plate 74 at an angle 80 of approximately 90°, although other angles between 0° and 180° are possible. Clasp 78 can be a circular tube or a rectangular tube, for example. Pintle hitch lock 72 further includes pin 32 and padlock 46.

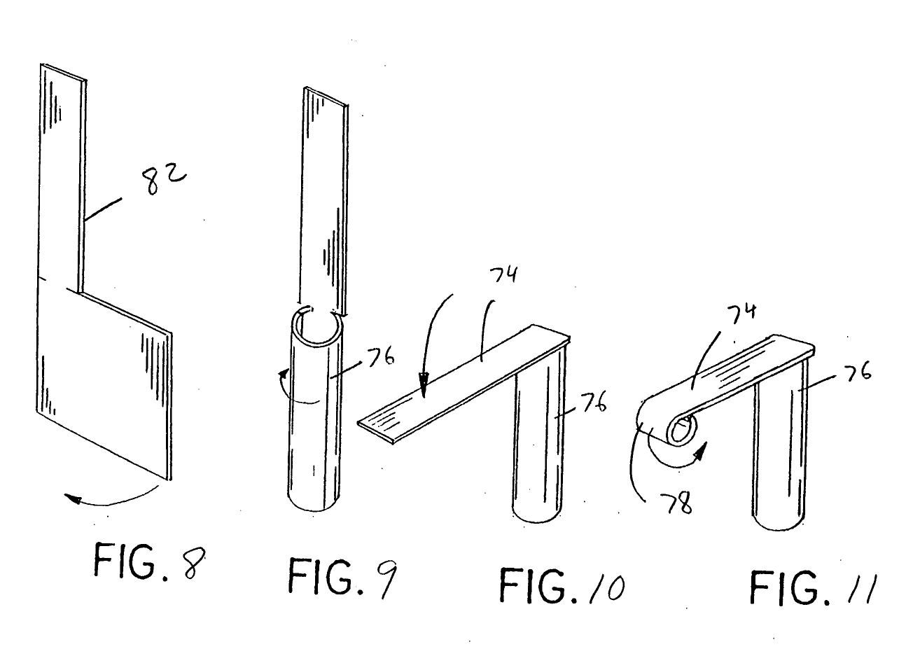

FIGS. 8-11 show the sequence of forming pintle hitch lock 72 from an L-shaped piece of sheet metal 82. In FIG. 9, jam 76 is formed. In FIG. 10, plate 74 is bent over one end of jam 76. In FIG. 10, clasp 78 is formed at the other end of plate 74.

In general, either the clasp or the jam can be a variety of cross-sectional shapes including circular, rectangular, polygonal, elliptical, oblong, other shapes or combinations thereof. Further, the jam can be a solid cross-section or hollow. Typical materials of the present invention can include steel, stainless steel, aluminum, other metals, carbon fiber, Kevlar, composites or combinations thereof. The construction of the present invention using aluminum materials can include the techniques of casting, bending/rolling, fabricating and welding, for example. The construction of the present invention using steel materials can include the techniques of casting, forging, bending/rolling, fabricating and welding, for example. Metals, particularly steel, used in manufacturing the present invention can be heat treated. Further, the present invention can be hard coated and anodized to improve corrosion resistance and resistance to cutting, for example, or other surface finishes.

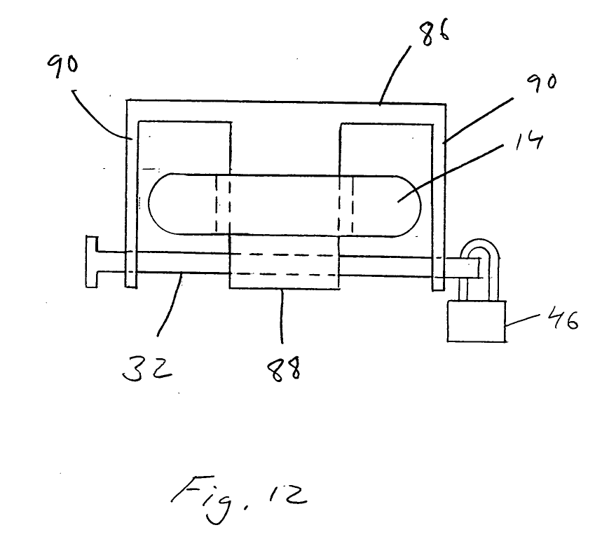

FIG. 12 shows another embodiment where the pintle hitch lock of the present invention includes plate 86 connected to both jam 88 and clasp 90. Pintle ring 14 is connected to a trailer tongue of a trailer. Jam 88 is inserted into the inside diameter of pintle ring 14. Pin 32 is inserted into holes in both jam 88 and clasp 90, and padlock 46 is locked onto pin 32, as was previously described, thereby locking the pintle hitch lock to pintle ring 14 and obstructing pintle ring 14 from connection to a pintle hitch.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A pintle hitch lock for locking a trailer hitch including a trailer tongue with a pintle ring, said pintle hitch lock comprising:
a jam configured for mounting through the pintle ring;
a clasp connected to said jam, said clasp being configured for connecting to the trailer tongue; and
a pin insertable through said clasp.

2. The pintle hitch lock of claim 1, wherein said pin includes a first end and a second end, said first end including a stop, said second end including an aperture.

3. The pintle hitch lock of claim 2, further including a padlock inserted through said aperture.

4. The pintle hitch lock of claim 1, further including a plate connecting said jam with said clasp.

5. The pintle hitch lock of claim 4, wherein said jam is one of a rectangular tube, a rectangular bar, a circular tube and a circular bar.

6. The pintle hitch lock of claim 5, wherein said jam extends from said plate at an angle of approximately 90°.

7. The pintle hitch lock of claim 4, wherein said clasp is one of a rectangular tube and a circular tube.

8. A trailer, comprising:
a trailer tongue including a pintle ring;
a pintle hitch lock connected to said trailer tongue, said pintle hitch lock including:
a jam being mounted through said pintle ring;
a clasp connected to said jam, said clasp connected to said trailer tongue; and
a pin inserted through both said clasp and said trailer tongue.

9. The trailer of claim 8, wherein said pin includes a first end and a second end, said first end including a stop, said second end including an aperture.

10. The trailer of claim 9, wherein said trailer tongue includes an adjustment channel having a first plate with a first plurality of holes and an opposing second plate with a second plurality of holes, said pin is mounted through one of said first plurality of holes and one of said second plurality of holes.

11. The trailer of claim 10, wherein said stop is on an outside of one of said first plate and said second plate, said aperture is on an other outside of said first plate and said second plate.

12. The trailer of claim 9, further including a padlock inserted through said aperture.

13. The trailer of claim 8, further including a plate connecting said jam with said clasp.

14. The trailer of claim 13, wherein said jam is one of a rectangular tube, a rectangular bar, a circular tube and a circular bar.

15. The trailer of claim 14, wherein said jam extends from said plate at an angle of approximately 90°.

16. The trailer of claim 13, wherein said clasp is one of a rectangular tube and a circular tube.

17. A method of locking from use a pintle ring on a trailer tongue of a trailer, said method comprising:
providing a pintle hitch lock including: a jam configured for mounting through said pintle ring; a clasp connected to said jam; and a pin insertable through said clasp;
inserting said jam through said pintle ring; and
connecting said clasp to the trailer tongue.

18. The method of claim 17, wherein the trailer tongue includes an adjustment channel having a first plate with a first plurality of holes and an opposing second plate with a second plurality of holes.

19. The method of claim 18, further including the step of mounting said pin through one of said first plurality of holes and one of said second plurality of holes, and said clasp.

20. The method of claim 19, further including the step of connecting a padlock to said pin.

21. A pintle hitch lock for locking a trailer hitch including a trailer tongue with a pintle ring, said pintle hitch lock comprising:
a jam configured for mounting through the pintle ring;
a clasp connected to said jam; and
a pin insertable through both said jam and said clasp.
